(19) United States
(12) Patent Application Publication
(10) Pub. No.: US 2023/0351928 A1
(43) Pub. Date: Nov. 2, 2023

(54) SHOE PLACARD ASSEMBLY

(71) Applicants: Walter Edwin Balfour, Chandler, AZ (US); Timothy W. Markison, Mesa, AZ (US); Jeremiah Johnston, Gilbert, AZ (US)

(72) Inventors: Walter Edwin Balfour, Chandler, AZ (US); Timothy W. Markison, Mesa, AZ (US); Jeremiah Johnston, Gilbert, AZ (US)

(21) Appl. No.: 18/140,897

(22) Filed: Apr. 28, 2023

Related U.S. Application Data
(60) Provisional application No. 63/363,851, filed on Apr. 29, 2022.

(51) Int. Cl. G09F 15/00

(52) U.S. Cl. CPC G09F 15/0062

(57) ABSTRACT

A shoe placard assembly includes a first stand piece, a second stand piece, and a placard piece that includes a surface for displaying information regarding a shoe, wherein: when unassembled, the first stand piece, the second stand piece, and the placard piece are each capable of lying substantially flat and are collectively capable of being stacked in a primary surface to primary surface manner to establish a first collective volume, and when assembled, the first stand piece, the second stand piece, and the placard piece form an in-shoe display that has a second collective volume, wherein the second collective volume is greater than the first collective volume.

### CROSS-REFERENCE TO RELATED APPLICATIONS

The present U.S. Utility Patent Application claims priority pursuant to 35 U.S.C. § 119(e) to U.S. Provisional Application No. 63/363,851, entitled “SHOE PLACARD ASSEMBLY”, filed Apr. 29, 2022, which is hereby incorporated herein by reference in its entirety and made part of the present U.S. Utility Patent Application for all purposes.

### STATEMENT REGARDING FEDERALLY SPONSORED RESEARCH OR DEVELOPMENT

Not Applicable.

### INCORPORATION-BY-REFERENCE OF MATERIAL SUBMITTED ON A COMPACT DISC

Not Applicable.

### BACKGROUND OF THE INVENTION

### Technical Field of the Invention

This invention relates generally to displays and more particularly to a shoe placard assembly.

### Description of Related Art

In-store advertising is done through signage, on-shelf displays, banners, and the like. For in-store shoe sales, there is limited space for advertising the benefits of a particular shoe. This is particularly true when the shoes are displayed on a wall with little spacing between the shoes.

### BRIEF DESCRIPTION OF THE SEVERAL VIEWS OF THE DRAWING(S)

FIG. 1 is a side view diagram of an example of a shoe marketing placard assembly in a shoe;

FIG. 2 is a rear-view diagram of an example of a shoe marketing placard assembly in a shoe;

FIG. 3 is a rear-view diagram of another example of a shoe marketing placard assembly in a shoe;

FIG. 4 is a cut-away side view diagram of an example of a shoe marketing placard assembly in a shoe;

FIG. 5 is a cut-away side view diagram of another example of a shoe marketing placard assembly in a shoe;

FIG. 6 is a side view diagram of another example of a shoe marketing placard assembly in a shoe;

FIG. 7 is a side view diagram of another example of a shoe marketing placard assembly in a shoe;

FIG. 8A is a diagram of an embodiment of a first stand piece of a shoe marketing placard assembly;

FIG. 8B is a diagram of an embodiment of a second stand piece of a shoe marketing placard assembly;

FIG. 8C is a diagram of an embodiment of the first and second stand pieces assembled to form a stand of a shoe marketing placard assembly;

FIG. 9 is a diagram of an embodiment of a placard piece of a shoe marketing placard assembly;

FIG. 10 is a diagram of another embodiment of a placard piece of a shoe marketing placard assembly;

FIG. 11 is a diagram of another embodiment of a placard piece of a shoe marketing placard assembly;

FIG. 12 is a diagram of an embodiment of a base piece of a shoe marketing placard assembly;

FIG. 13 is an exploded view diagram of an example of assembling a shoe marketing placard assembly;

FIG. 14 is an exploded view diagram of another example of assembling a shoe marketing placard assembly; and

FIG. 15 is an isometric view diagram of an example of a shoe marketing placard assembly.

### DETAILED DESCRIPTION OF THE INVENTION

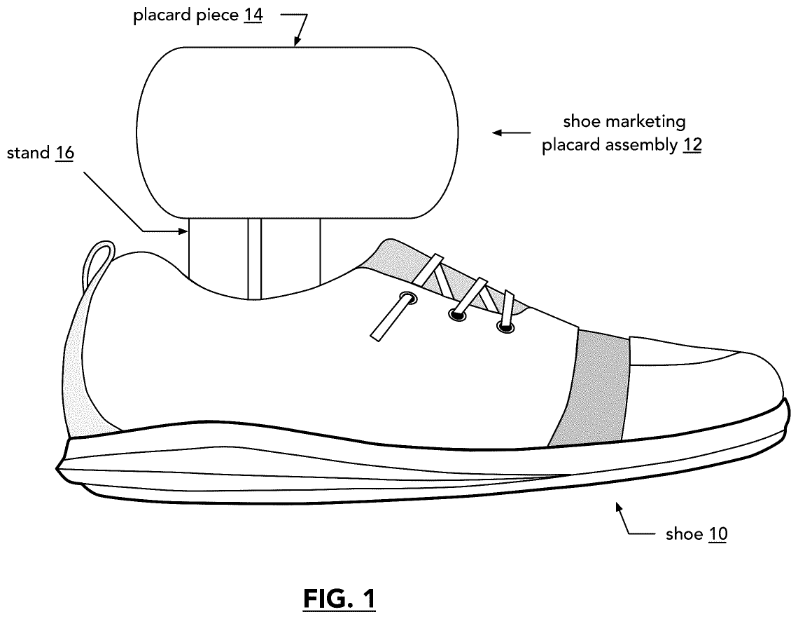

FIG. 1 is a side view diagram of an example of a shoe marketing placard assembly 12 in a shoe 10. The shoe marketing placard assembly 12 includes a placard piece 14 and a stand 16. The stand 16 includes a mounting slot for the placard piece 14. Each of the elements of the shoe marketing placard assembly 12 are comprised of one or more materials. The materials include, but are not limited to, plastic, metal, aluminum, carbon fiber, rubber, wood, paper, glass, leather, a composite material, ceramic, and foam.

The placard piece 14 includes one or more surface areas (e.g., two square inches or more) on which one or more decals can be placed. The one or more decals are used to display information regarding a particular shoe. A decal is adhered to a surface area in a variety of ways. For example, the decal is adhered to the surface area using an adhesive. As another example, the decal is adhered to the surface area using magnetic coupling. As a further example, the decal is adhered to the surface area using static electricity. As a still further example, the decal is adhered to the surface area using hardware.

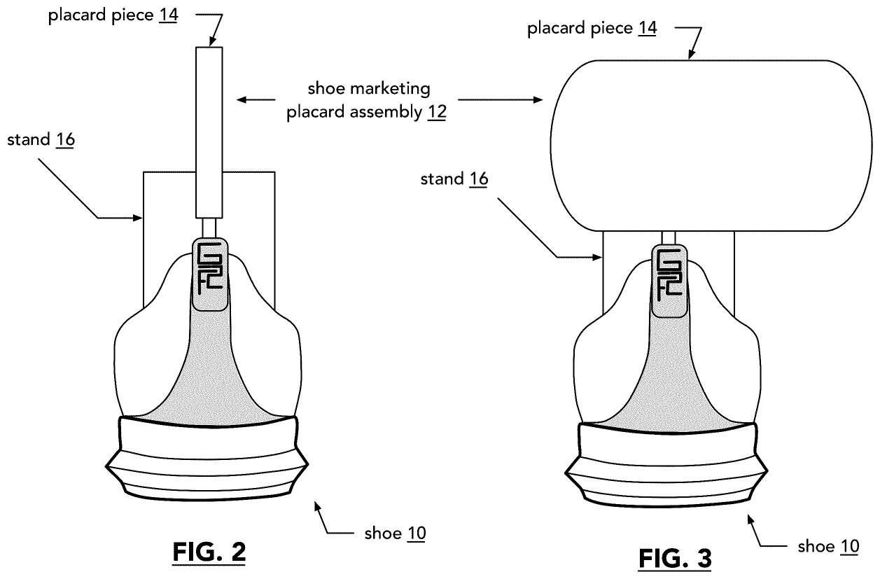

FIG. 2 is a rear-view diagram of an example of a shoe marketing placard assembly 12 in a shoe 10. In this example, the placard piece 14 is positioned within the stand 16 such that its surface areas are aligned with the length of the shoe.

FIG. 3 is a rear-view diagram of another example of a shoe marketing placard assembly 12 in a shoe 10. In this example, the placard piece 14 is positioned within the stand 16 such that its surface areas are aligned with the width of the shoe. By changing the orientation of the placard piece within the stand allows for different positioning of a shoe sale display.

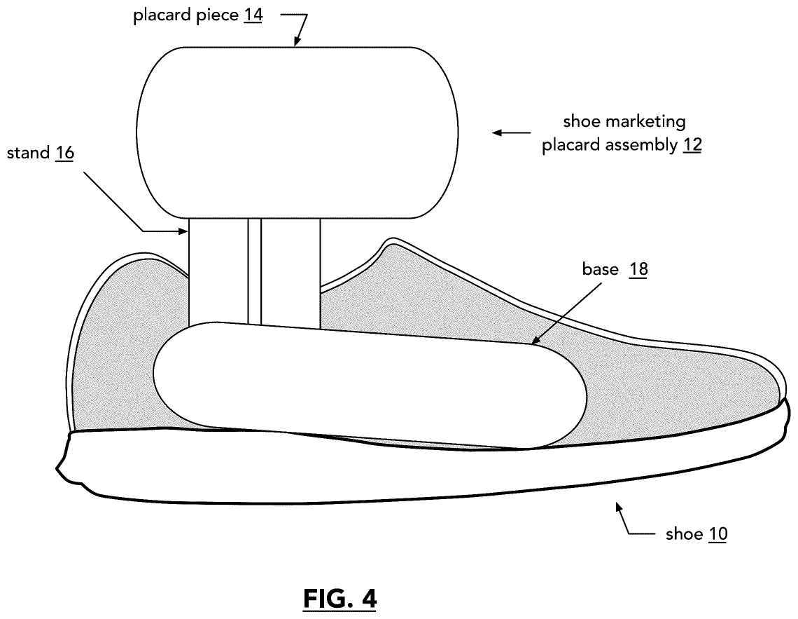

FIG. 4 is a cut-away side view diagram of an example embodiment of a shoe marketing placard assembly 12 in a shoe 10. In this embodiment, the shoe marketing placard assembly 12 includes a placard piece 14, a stand 16, and a base 18. The stand 16 includes a mounting slot for the placard piece 14. The base 18 includes a mounting slot for the stand 16.

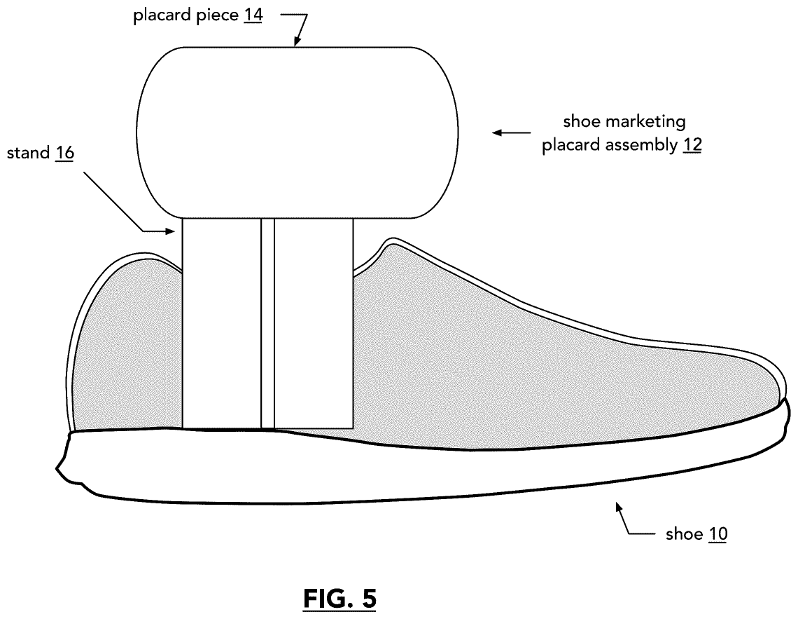

FIG. 5 is a cut-away side view diagram of another example embodiment of a shoe marketing placard assembly 12 in a shoe 10. In this embodiment, the shoe marketing placard assembly 12 includes a placard piece 14 and a stand 16. The stand 16 includes a mounting slot for the placard piece 14 and fits within the opening of the shoe which holds it in place.

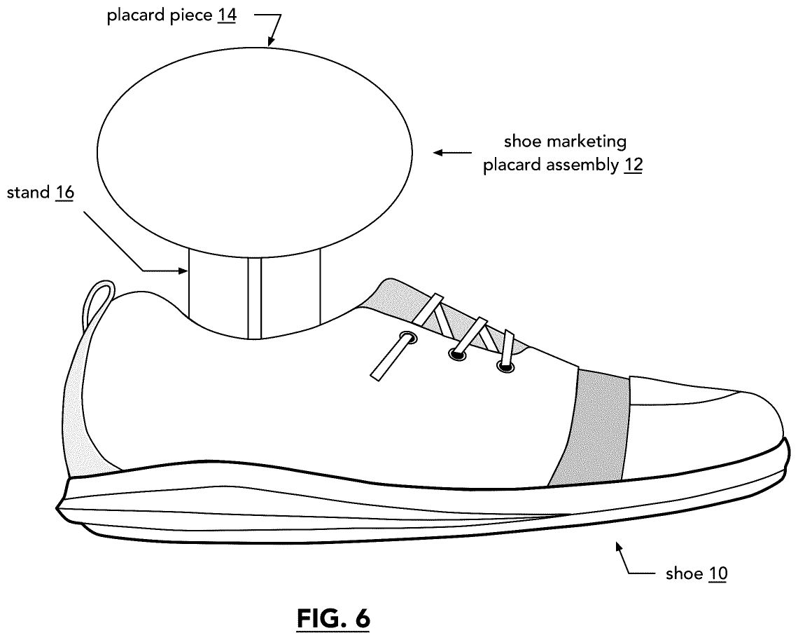

FIG. 6 is a side view diagram of another example of a shoe marketing placard assembly 12 in a shoe 10. In this example, the shape of the placard piece 14 is circular or oval shaped and mates with the stand 16.

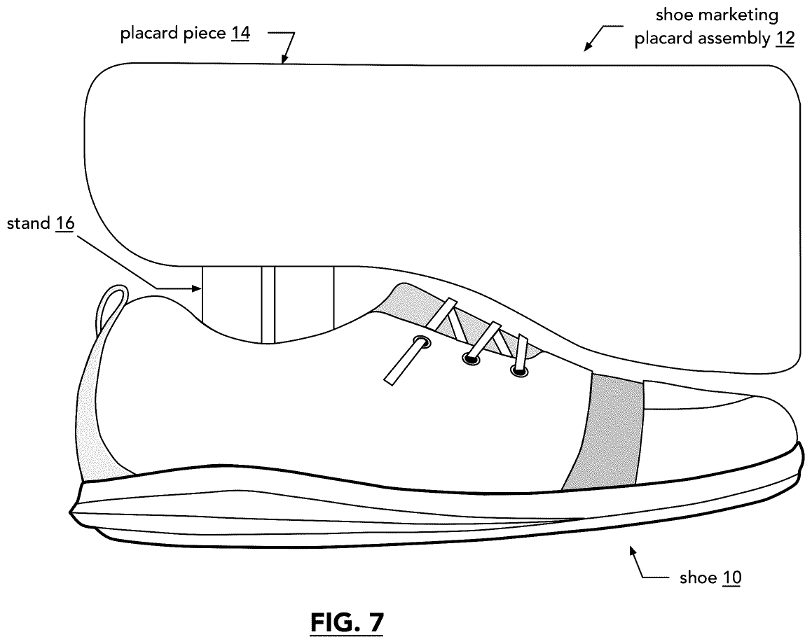

FIG. 7 is a side view diagram of another example of a shoe marketing placard assembly 12 in a shoe 10. In this example, the shape of the placard piece 14 follows the shape of the top of the shoe. The placard piece 14 mates with the stand 16.

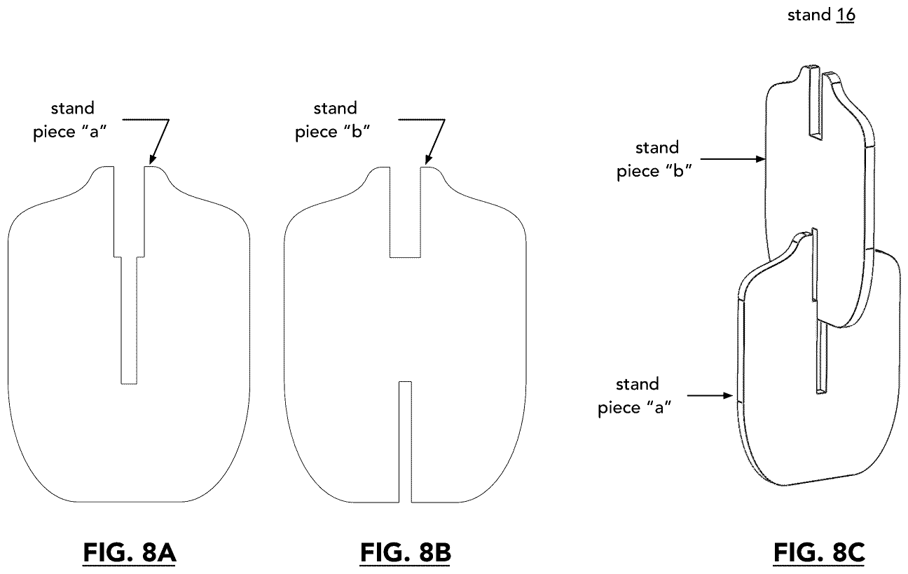

FIG. 8A is a diagram of an embodiment of a first stand piece “a” of a stand 16 of a shoe marketing placard assembly 12. Stand piece “a” includes a dual width slot on one end of the piece.

FIG. 8B is a diagram of an embodiment of a second stand piece “b” of a stand 16 of a shoe marketing placard assembly 12. Stand piece “b” includes a single width slot on one end of the piece and another single width slot on the other end.

FIG. 8C is a diagram of an embodiment of the first and second stand pieces assembled without the use of hardware and/or adhesive, to form a stand 16 of a shoe marketing placard assembly. As shown, stand piece “b” slides into the dual width slot of stand piece “a”. When fully in place, the wider slot forms the mounting slot for the placard piece. Note that other configurations of slots can be used to mate pieces “a” and “b” together. Also, the mounting slot for the placard piece may be larger, smaller, or of the same width as the slots for mounting pieces “a” and “b” together.

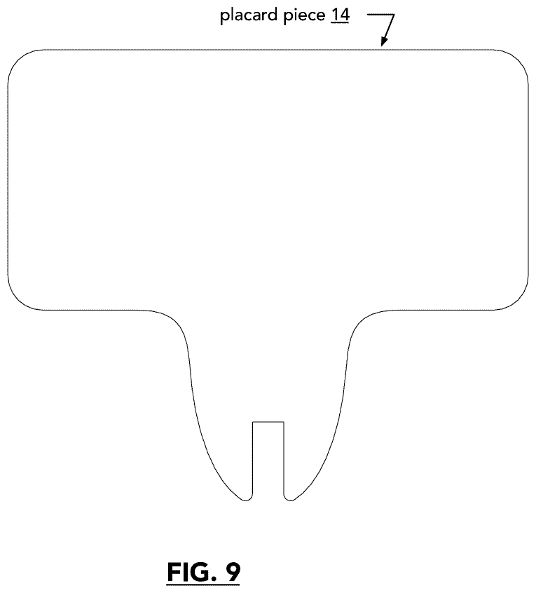

FIG. 9 is a diagram of an embodiment of a placard piece 14 of a shoe marketing placard assembly that includes a square to rectangular perimeter shape. The slot of the placard piece mates to the mounting slot of the stand without the use of hardware and/or adhesive, which can be rotated in 90-degree increments.

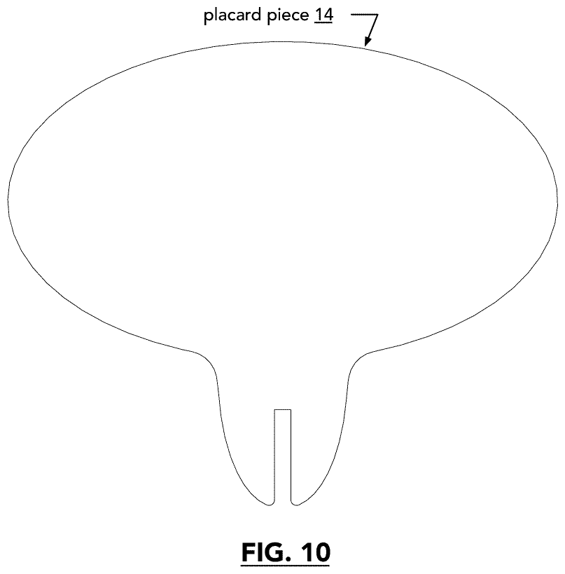

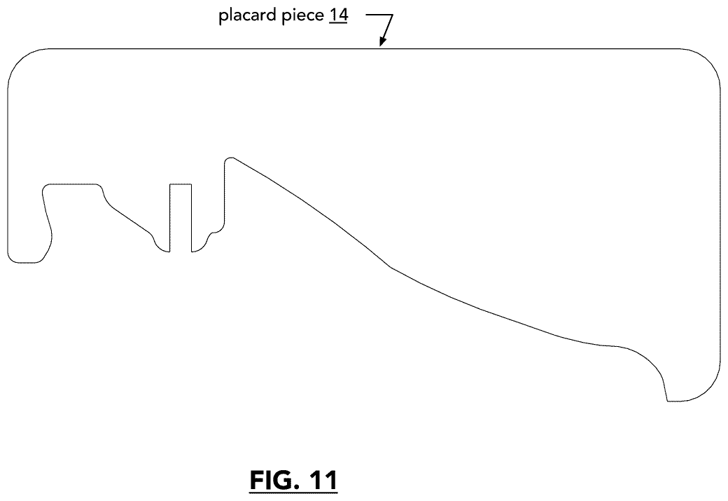

FIG. 10 is a diagram of another embodiment of a placard piece 14 of a shoe marketing placard assembly that includes a round to oval perimeter shape. The slot of the placard piece mates to the mounting slot of the stand, which can be rotated in 90-degree increments.

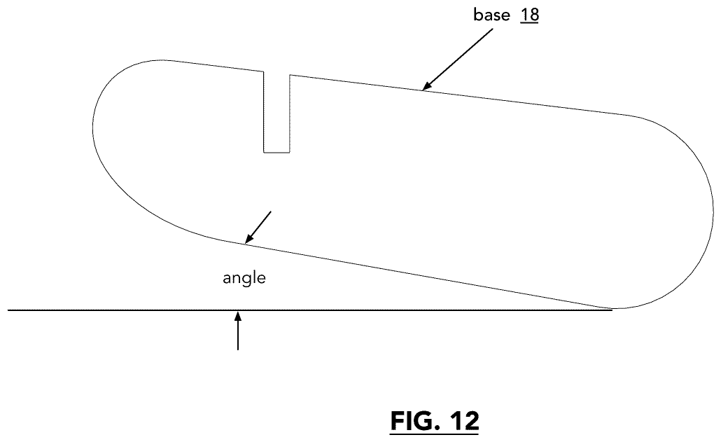

FIG. 11 is a diagram of another embodiment of a placard piece 14 of a shoe marketing placard assembly that includes a perimeter shape that follows the outline of a shoe. The slot of the placard piece mates to the mounting slot of the stand, which can be rotated in 90-degree increments.

FIG. 12 is a diagram of an embodiment of a base piece 18 of a shoe marketing placard assembly. The base 18 includes a slot for mating with the stand. The base 18 includes an angular side where the angle conforms to the heel to toe angle of shoes (e.g., 0 to 20 degrees).

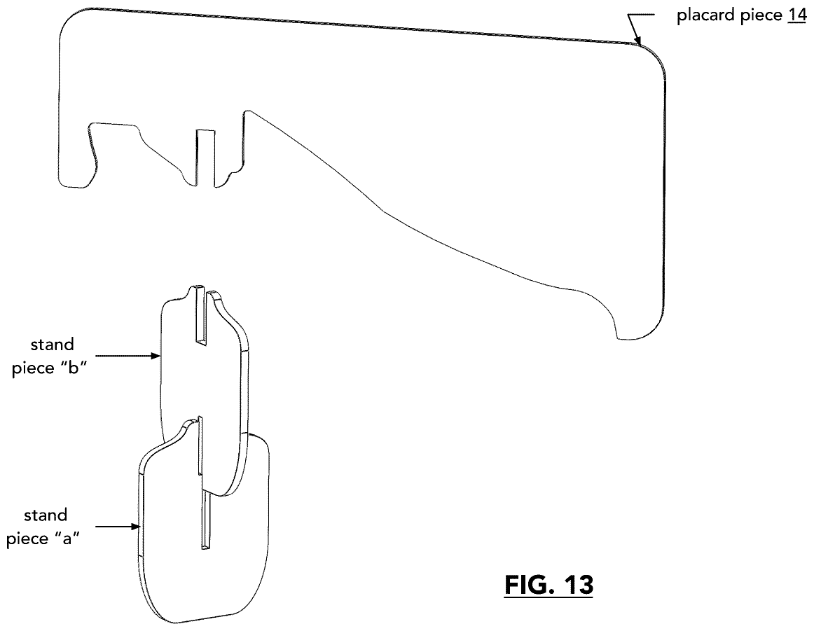

FIG. 13 is an exploded view diagram of an example of assembling a shoe marketing placard assembly 12 that does not include a base. As shown, stand pieces “a” and “b” mate to form the stand and, when connected, form a mating slot for the placard piece 14.

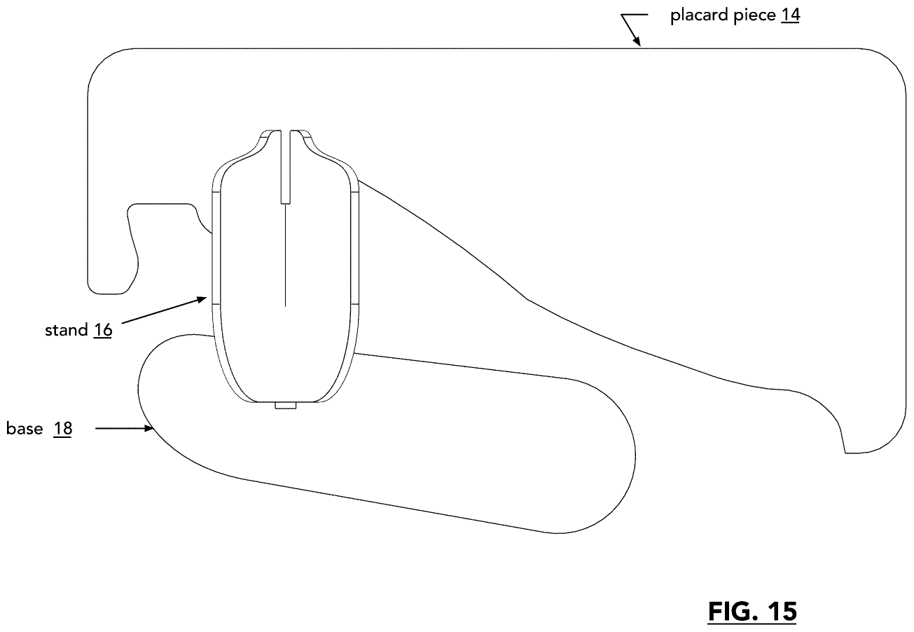

In an example embodiment of the assembly 12 which includes the first stand piece, the second stand piece and the placard piece 14, the assembly 12 establishes a second collective volume greater than that of a volume of an unassembled assembly which will be discussed with greater detail in FIG. 15.

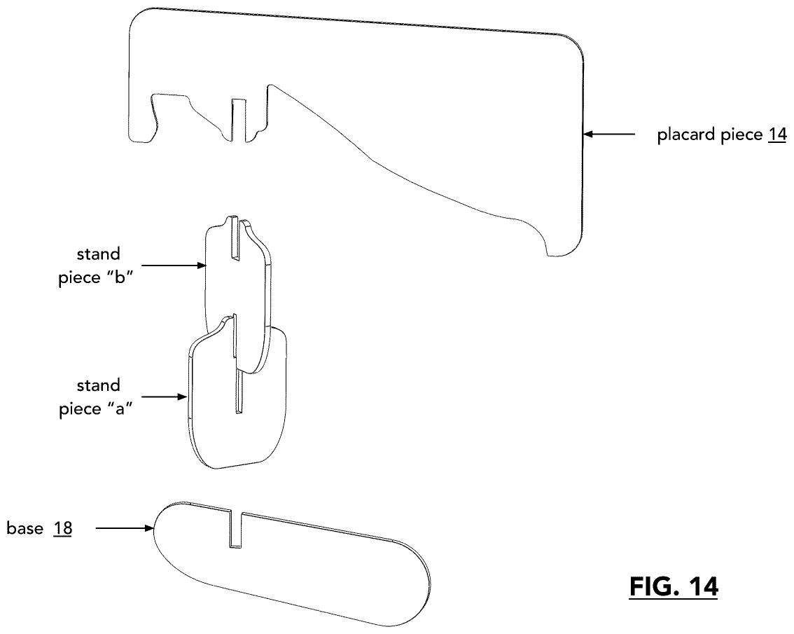

FIG. 14 is an exploded view diagram of another example of assembling a shoe marketing placard assembly 12 without the use of hardware and/or adhesive that includes a base 18. As shown, stand pieces “a” and “b” mate to form the stand and, when connected, form a mating slot for the placard piece 14. The “X” formed by stand pieces “a” and “b” fit into the mounting slot of the base 18.

In another embodiment, stand pieces “a” and “b” include another slot, which forms a base mounting slot when coupled together. The base mounting slot of the stand mates with the slot of the base 18.

FIG. 15 is an isometric view diagram of an example of a shoe marketing placard assembly 12, which includes the placard piece 14, the stand 16, and the base 18. With such a construction of the shoe marketing placard assembly, the pieces can be shipped unassembled in an envelope to users of the assembly 12 due to each piece respectively, being capable of lying flat, provides the ability for the pieces to be oriented in a primary surface to primary surface manner. This reduces the cost of shipping and allows for the shoe marketing placard assembly to be used with a wide variety of footwear (e.g., shoes, boots, etc.) When all pieces are oriented in a primary surface to primary surface manner, a collective volume can be established.

In an example, when the first stand piece, the second stand piece, and the placard piece 14 are unassembled and in a primary surface to primary surface manner, establish a first collective volume and, when assembled, establish a second collective volume. For example, the first collective volume is 6 inches, by 3 inches, by ¾ of an inch and the second collective volume is 6 inches, by 3 inches, by 3 inches.

In another example, when the first stand piece, the second stand piece, the placard piece 14, and the base piece 18, are unassembled and in a primary surface to primary surface manner, a first collective volume is established and, when assembled, establishes a second collective volume. For example, the first collective volume is 6 inches, by 3 inches, by 1 inch and the second collective volume is 6 inches, by 3 inches, by 6 inches.

It is noted that terminologies as may be used herein such as bit stream, stream, signal sequence, etc. (or their equivalents) have been used interchangeably to describe digital information whose content corresponds to any of a number of desired types (e.g., data, video, speech, text, graphics, audio, etc. any of which may generally be referred to as ‘data’).

As may be used herein, the terms “substantially” and “approximately” provide an industry-accepted tolerance for its corresponding term and/or relativity between items. For some industries, an industry-accepted tolerance is less than one percent and, for other industries, the industry-accepted tolerance is 10 percent or more. Other examples of industry-accepted tolerance range from less than one percent to fifty percent. Industry-accepted tolerances correspond to, but are not limited to, component values, integrated circuit process variations, temperature variations, rise and fall times, thermal noise, dimensions, signaling errors, dropped packets, temperatures, pressures, material compositions, and/or performance metrics. Within an industry, tolerance variances of accepted tolerances may be more or less than a percentage level (e.g., dimension tolerance of less than +/−1%). Some relativity between items may range from a difference of less than a percentage level to a few percent. Other relativity between items may range from a difference of a few percent to magnitude of differences.

As may also be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”.

As may even further be used herein, the term “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item.

As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1. As may be used herein, the term “compares unfavorably”, indicates that a comparison between two or more items, signals, etc., fails to provide the desired relationship.

As may be used herein, one or more claims may include, in a specific form of this generic form, the phrase “at least one of a, b, and c” or of this generic form “at least one of a, b, or c”, with more or less elements than “a”, “b”, and “c”. In either phrasing, the phrases are to be interpreted identically. In particular, “at least one of a, b, and c” is equivalent to “at least one of a, b, or c” and shall mean a, b, and/or c. As an example, it means: “a” only, “b” only, “c” only, “a” and “b”, “a” and “c”, “b” and “c”, and/or “a”, “b”, and “c”.

One or more embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof.

In addition, a flow diagram may include a “start” and/or “continue” indication. The “start” and “continue” indications reflect that the steps presented can optionally be incorporated in or otherwise used in conjunction with one or more other routines. In addition, a flow diagram may include an “end” and/or “continue” indication. The “end” and/or “continue” indications reflect that the steps presented can end as described and shown or optionally be incorporated in or otherwise used in conjunction with one or more other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

The one or more embodiments are used herein to illustrate one or more aspects, one or more features, one or more concepts, and/or one or more examples. A physical embodiment of an apparatus, an article of manufacture, a machine, and/or of a process may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

While particular combinations of various functions and features of the one or more embodiments have been expressly described herein, other combinations of these features and functions are likewise possible. The present disclosure is not limited by the particular examples disclosed herein and expressly incorporates these other combinations.

What is claimed is:

1. A shoe placard assembly comprises:
a first stand piece;
a second stand piece; and
a placard piece that includes a surface for displaying information regarding a shoe, wherein:
when unassembled, the first stand piece, the second stand piece, and the placard piece are each capable of lying substantially flat and are collectively capable of being stacked in a primary surface to primary surface manner to establish a first collective volume; and
when assembled, the first stand piece, the second stand piece, and the placard piece form an in-shoe display that has a second collective volume, wherein the second collective volume is greater than the first collective volume.

2. The shoe placard assembly of claim 1, wherein the first stand piece and the second stand piece couple via respective interconnecting mechanisms, wherein the first stand piece and or the second stand piece includes a second interconnecting mechanism.

3. The shoe placard assembly of claim 2, wherein:
when the first stand piece and the second stand piece are coupled:
the second interconnecting mechanism of the first stand piece and or the second stand piece forms a first coupling mechanism to engage a placard mounting mechanism of the placard piece; and
a second coupling mechanism.

4. The shoe placard assembly of claim 1 further comprises:
a base piece operable to fit into the shoe, wherein the base piece has a base mounting mechanism operable to engage the second coupling mechanism, wherein:
when unassembled, the first stand piece, the second stand piece, the placard piece, and the base piece are each capable of lying substantially flat and are collectively capable of being stacked in the primary surface to primary surface manner to establish a third collective volume, wherein the third collective volume is greater than the first collective volume, wherein the third collective volume is less than the second collective volume; and
when assembled, the first stand piece, the second stand piece, the placard piece and the base piece form the in-shoe display having a fourth collective volume, and wherein the fourth collective volume is greater than the second collective volume.

5. The shoe placard assembly of claim 1, wherein the shoe placard assembly assembles and holds shape without hardware and or adhesive.

6. The shoe placard assembly of claim 1, wherein the first stand piece and the second stand piece when coupled, are positioned within the shoe in a first orientation such that the surface for displaying information of the placard piece is aligned with a length of the shoe.

7. The shoe placard assembly of claim 1, wherein the first stand piece and the second stand piece when coupled, are positioned within the shoe in a second orientation such that the surface for displaying information of the placard piece is aligned with a width of the shoe.

8. The shoe placard assembly of claim 1, wherein the shoe placard assembly is comprised of one or more of:
plastic;
metal;
aluminum;
carbon fiber;
rubber;
wood;
paper;
glass;
leather;
a composite material;
ceramic; and
foam.

9. An in-shoe display comprises:
a stand; and
a placard piece coupled to the stand, wherein the placard has a primary surface for displaying information regarding a shoe, wherein the stand fits within the shoe and the placard is substantially outside of the shoe.

10. The in-shoe display of claim 9, wherein the placard piece is removable from the stand.

11. The in-shoe display of claim 9, wherein the placard piece is fixed to the stand.

12. The in-shoe display of claim 9, wherein the stand includes:
a first stand piece; and
a second stand piece.

13. The in-shoe display of claim 9, wherein the first stand piece and the second stand piece couple via respective interconnecting mechanisms to form the stand piece, wherein the first stand piece and or the second stand piece includes a second interconnecting mechanism.

14. The in-shoe display of claim 12, wherein the stand includes:
a first coupling mechanism to engage a placard mounting mechanism of the placard piece.

15. The in-shoe display of claim 9 further comprises:
a base piece operable to fit into the shoe, wherein the base piece has a base mounting mechanism operable to engage a second coupling mechanism of the stand.

16. The in-shoe display of claim 9, wherein the in-shoe display assembles and holds shape without hardware and or adhesive.

17. The shoe placard assembly of claim 9, wherein the stand piece is positioned within the shoe, in a first orientation such that the surface for displaying information of the placard piece is aligned with a length of the shoe.

18. The shoe placard assembly of claim 9, wherein the stand piece is positioned within the shoe, in a second orientation such that the surface for displaying information of the placard piece is aligned with a width of the shoe.

19. The in-shoe display of claim 9, wherein the in-shoe display is comprised of one or more of:
plastic;
metal;
aluminum;
carbon fiber;
rubber;
wood;
paper;
glass;
leather;
a composite material;
ceramic; and
foam.
